(19) United States
(12) Patent Application Publication
(10) Pub. No.: US 2010/0165302 A1
(43) Pub. Date: Jul. 1, 2010

(54) PROJECTOR AND METHOD OF CONTROLLING THE SAME

(75) Inventor: Takashi Ozawa, Shiojiri-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/632,037

(22) Filed: Dec. 7, 2009

(30) Foreign Application Priority Data
Dec. 25, 2008 (JP) 2008-329378

(51) Int. Cl. G03B 21/14

(52) U.S. Cl. 353/70; 353/121

(57) ABSTRACT

A projector adapted to perform a keystone distortion correction for correcting keystone distortion of an image projected on a projection surface, includes: a fluctuation detection section adapted to start detection of fluctuation state of the projector in response to a predetermined instruction signal; an angle detection section adapted to detect an installation angle of the projector; a distortion correction section adapted to perform the keystone distortion correction, in response to detection of a fluctuation settled state by the fluctuation detection section, in accordance with the installation angle detected by the angle detection section; and a control section adapted to terminate the detection of the fluctuation state by the fluctuation detection section in response to elapse of second time while keeping the fluctuation settled state from completion of the keystone distortion correction by the distortion correction section.

### CROSS-REFERENCE

The present application claims priority from Japanese Patent Application No. 2008-329378 filed on Dec. 25, 2008, which is hereby incorporated by reference in its entirety.

### BACKGROUND

In the projector for projecting an image on a projection surface such as a screen, if the image is projected in the condition in which the projector is tilted with respect to the projection surface, a phenomenon (keystone distortion) that the image displayed on the projection surface is distorted to have a trapezoidal shape occurs. Therefore, there is proposed a projector which detects the tilt (installation angle) of the projector, and automatically corrects the keystone distortion caused by the tilt. A projector, which, in response to any variation in the installation angle, performs keystone distortion correction in accordance with the installation angle is disclosed in Japanese Patent Publication No. 2003-283963. According to such a projector, even the user who is not familiar to the operation of the projector can easily obtain the image on which the keystone distortion correction is executed.

However, if an automatic keystone distortion correction function is enabled, when the variation in the installation angle occurs during the adjustment of the installation angle of the projector by the user, or in the case in which shaking is accidentally provided to the projector, the automatic keystone distortion correction function might operate. When the automatic keystone distortion correction function operates, the image of the projection surface is varied and looks as if it blinks, and therefore, there arises a problem that the observer of the projector feels uncomfortable.

### SUMMARY

Various embodiments may solve at least a part of the problem described above.

According to at least one embodiment of the disclosure, there is provided a projector adapted to perform a keystone distortion correction for correcting keystone distortion of an image projected on a projection surface, including a fluctuation detection section adapted to start detection of fluctuation state of the projector in response to a predetermined instruction signal, an angle detection section adapted to detect an installation angle of the projector, a distortion correction section adapted to perform the keystone distortion correction, in response to detection of a fluctuation settled state by the fluctuation detection section, in accordance with the installation angle detected by the angle detection section, and a control section adapted to terminate the detection of the fluctuation state by the fluctuation detection section in response to elapse of second time while keeping the fluctuation settled state from completion of the keystone distortion correction by the distortion correction section.

According to the projector, the fluctuation detection section starts the detection of the fluctuation state of the projector in response to the predetermined instruction signal. Then, the distortion correction section executes the keystone distortion correction in accordance with the installation angle detected by the angle detection section when the first time has elapsed while keeping the state (the fluctuation settled state) in which the fluctuation is settled. In other words, the projector executes the automatic keystone distortion correction function. Then, the control section terminates the detection of the fluctuation by the fluctuation detection section when the second time has elapsed while keeping the fluctuation settled state from the completion of the keystone distortion correction. Thus, it becomes possible to prevent the keystone distortion correction from being executed during the period in which the projector is fluctuating, by performing the keystone distortion correction when the first time has elapsed from when the fluctuation of the projector has been settled. In other words, the flicker in the projection image caused by performing the keystone distortion correction can be reduced. Further, by terminating the detection of the fluctuation state when the second time has elapsed from the completion of the keystone distortion correction, the projector never performs the keystone distortion correction after terminating the detection of the fluctuation state even if the projector is fluctuated, thus the flicker in the projection image caused by performing the keystone distortion correction can be prevented. As described above, the projector can reduce the flicker in the projection image due to the automatic keystone distortion correction function.

According to at least one embodiment of the disclosure, in the projector of the above embodiment, the fluctuation detection section is formed with the angle detection section, and adopts a variation state of the installation angle detected by the angle detection section as the fluctuation state of the projector.

According to the projector, the fluctuation detection section is formed of the angle detection section. Thus, since the circuit configuration as the fluctuation detection section becomes unnecessary, the circuit configuration of the projector can be simplified.

According to at least one embodiment of the disclosure, in the projector of the above embodiment, there is further provided a time changing section capable of changing the second time.

According to the projector, the time changing section capable of changing the second time is provided. Thus, the second time from the completion of the keystone distortion correction to the termination of the detection of the fluctuation state can be changed. Therefore, the second time can be changed in accordance with the intention of the user.

According to at least one embodiment of the disclosure, in the projector of the above embodiment, the predetermined instruction signal is a signal corresponding to powering on of the projector.

According to the projector, the fluctuation detection section starts the detection of the fluctuation state of the projector in response to the powering on of the projector. Then, when the first time has elapsed from when the fluctuation of the projector has been settled, the keystone distortion correction is performed. Further, when the second time has elapsed from the completion of the keystone distortion correction, the detection of the fluctuation state is terminated. Thus, it becomes possible to perform the automatic keystone distortion correction function when powering on the projector, and further, the flicker in the projection image due to the automatic keystone distortion correction function can be prevented.

According to at least one embodiment of the disclosure, in the projector of the above embodiment, an input operation section adapted to receive an input operation is further provided, and the predetermined instruction signal is a signal corresponding to a predetermined input operation to the input operation section.

According to the projector, the fluctuation detection section starts the detection of the fluctuation state of the projector when the predetermined input operation to the input operation section is performed. Then, when the first time has elapsed from when the fluctuation of the projector has been settled, the keystone distortion correction is performed. Further, when the second time has elapsed from the completion of the keystone distortion correction, the detection of the fluctuation state is terminated. Thus, it becomes possible to perform the automatic keystone distortion correction function when the predetermined input operation is performed, and further, the flicker in the projection image due to the automatic keystone distortion correction function can be prevented.

According to at least one embodiment of the disclosure, there is provided a method of controlling a projector adapted to perform a keystone distortion correction for correcting keystone distortion of an image projected on a projection surface, including (a) starting detection of fluctuation state of the projector in response to a predetermined instruction signal, (b) detecting an installation angle of the projector, (c) performing the keystone distortion correction, in response to detection of the fluctuation settled state in step (a), in accordance with the installation angle detected in step (b), and (d) terminating the detection of the fluctuation state in step (a) in response to elapse of second time while keeping the fluctuation settled state from completion of the keystone distortion correction in step (c).

According to the method of controlling the projector, it becomes possible to prevent the keystone distortion correction from being executed during the period in which the projector is fluctuating, by performing the keystone distortion correction when the fluctuation of the projector has been settled. In other words, the flicker in the projection image caused by performing the keystone distortion correction may be reduced. Further, by terminating the detection of the fluctuation state when the second time has elapsed from the completion of the keystone distortion correction, the projector never performs the keystone distortion correction after terminating the detection of the fluctuation state even if the projector is fluctuated, thus the flicker in the projection image caused by performing the keystone distortion correction can be prevented. As described above, in the method of controlling a projector, the flicker in the projection image due to the automatic keystone distortion correction function can be reduced.

Further, in the case in which the projector and the method of controlling a projector described above are configured using the computer provided to the projector, the embodiments described above can be configured as aspects of a program for realizing the function, or a recording medium recording the program in a computer readable manner. As a recording medium, a flexible disk, a CD-ROM, a magnetooptical disk, an IC card, a ROM cartridge, an internal storage (e.g., a memory device such as RAM or ROM) and an external storage of the projector, or other various medium the computer can read can be used.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a block diagram showing a schematic configuration of a projector according to an embodiment.

FIG. 2 is a front view showing a liquid crystal light valve.

FIG. 3 is an explanatory diagram showing the principle of installation angle detection in the projector.

FIGS. 4A through 4E are explanatory diagrams for explaining the keystone distortion and showing the state in which no keystone distortion correction is executed on image data, wherein FIG. 4A is a front view of the liquid crystal light valve viewed from the light entrance surface side, FIG. 4B is a side view showing how the projector performs projection horizontally, FIG. 4C is a front view showing a projection image displayed on a screen, FIG. 4D is a side view showing how the projection is performed in the condition in which the projector is tilted, and FIG. 4E is a front view showing the projection image displayed on the screen.

FIGS. 5A and 5B are explanatory diagrams for explaining the keystone distortion correction, wherein FIG. 5A is a front view of the liquid crystal light valve viewed from the light entrance surface side, and FIG. 5B is a front view showing the projection image displayed on the screen when performing oblique projection.

FIG. 6 is a flowchart of a process executed when the projector is powered on.

FIG. 7 is a flowchart of a keystone distortion correction of the projector.

FIG. 8 is a flowchart of a process executed when a keystone distortion correction key of the projector is held down.

FIG. 9 is a diagram of a menu screen for changing second time.

### DESCRIPTION OF EMBODIMENT

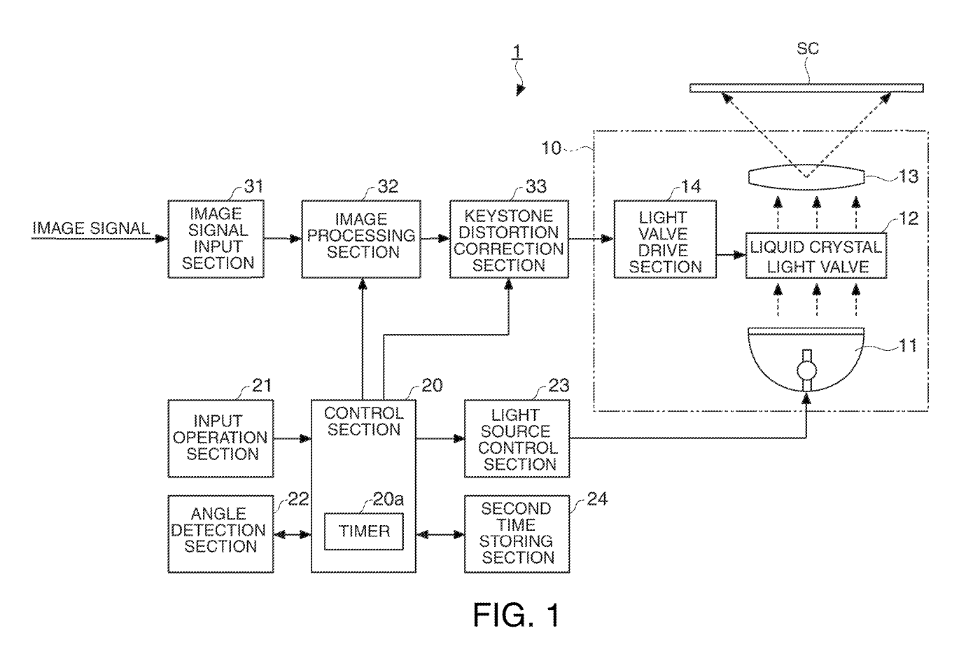

FIG. 1 is a block diagram showing a schematic configuration of a projector according to the present embodiment. The internal configuration of the projector 1 will be explained with reference to FIG. 1.

The projector 1 is provided with an image projection section 10, a control section 20, an input operation section 21, an angle detection section 22, a light source control section 23, a second time storing section 24, an image signal input section 31, an image processing section 32, and a keystone distortion correction section 33, and so on.

The image projection section 10 is provided with a light source 11 formed of a discharge light source such as a super-high pressure mercury lamp or a metal halide lamp, or a solid-state light source such as a light emitting diode (LED) or a laser device, a liquid crystal light valve 12 as a light modulation device for modulating the light emitted from the light source 11, a projection lens 13 as a projection optical section for enlargedly projecting the modulated light emitted from the liquid crystal light valve 12 on a screen SC or the like, and a light valve drive section 14 for driving the liquid crystal light valve 12.

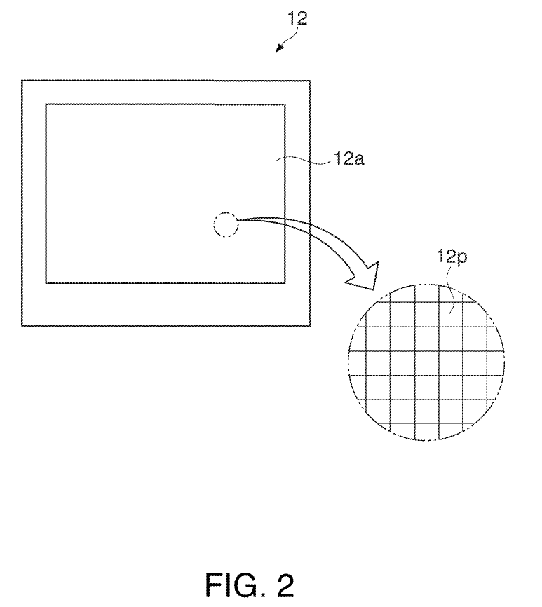

FIG. 2 is a front view showing the liquid crystal light valve. The liquid crystal light valve 12 is composed mainly of a liquid crystal panel having a liquid crystal material encapsulated between a pair of transparent substrates. As shown in FIG. 2, on the inner surface of each of the transparent substrates, there are formed transparent electrodes (pixel electrodes) capable of applying drive voltages to the liquid crystal material in the respective microscopic areas (the pixels 12p) in a matrix in a rectangular area (a pixel area 12a). When the light valve drive section 14 drives each of the pixels 12p of the liquid crystal light valve 12 by applying, to the pixel, the drive voltage corresponding to the image signal, the pixel 12p transmits the source light with the transmission corresponding to the image signal.

The light emitted from the light source 11 is modulated while being transmitted through the liquid crystal light valve 12, and the projection lens 13 projects the light thus modulated, thereby displaying the image corresponding to the image signal on the screen SC or the like.

Going back to FIG. 1, the control section 20 is provided with a central processing unit (CPU), a random access memory (RAM) used as a temporary storage for various data, a nonvolatile memory such as a mask read only memory (ROM), a flash memory, or a ferroelectric RAM (FeRAM), and so on (neither of them is shown), and functions as a computer. The CPU operates along a control program stored in the nonvolatile memory, thus the control section 20 integrally controls the operation of the projector 1.

Further, the control section 20 is provided with a timer 20a for measuring time. In the present embodiment, the timer 20a measures first time and second time.

The input operation section 21 is provided with, for example, a plurality of operation keys for providing various instructions to the projector 1. As the keys provided to the input operation section 21, there can be cited, for example, a “power key” for switching ON/OFF the power, an “input switching key” for switching the input source, a “menu key” for switching display/nondisplay of the menu screen for performing various settings, a “cursor key” used, for example, for moving the cursor in the menu screen, a “determination key” for determining the various settings, and a “keystone distortion correction key” for performing the keystone distortion correction. When the user operates the input operation section 21, the input operation section 21 outputs an operation signal corresponding to the operation by the user to the control section 20. It should be noted that the input operation section 21 can be arranged to have a configuration of including a remote control signal receiving section (not shown) and a remote controller (not shown) capable of performing remote control. In this case, the remote controller emits an operation signal, for example, an infrared ray corresponding to the content of the operation by the user, thus the remote control signal receiving section receives the operation signal and transmits it to the control section 20.

The angle detection section 22 is configured including an acceleration sensor or the like, and detects the installation angle of the projector 1 based on the instruction of the control section 20. Then, the angle detection section 22 informs the control section 20 of the installation angle thus detected.

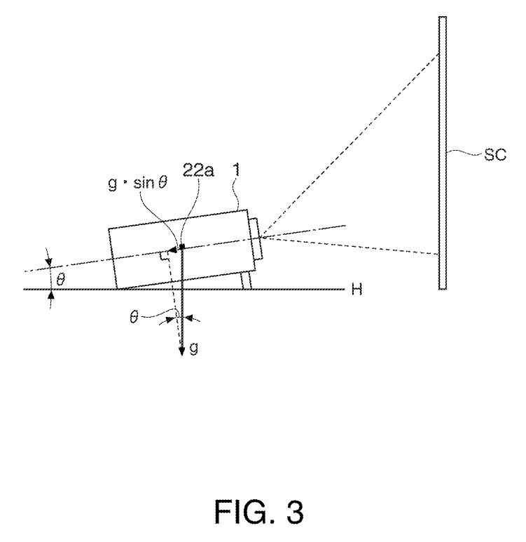

Here, the method of detecting the installation angle of the projector 1 will be explained. FIG. 3 is an explanation diagram showing the principle of detecting the installation angle of the projector 1. The present diagram shows the projector 1, the installation plane H thereof, and the screen SC viewed from the right side surface thereof. It is assumed that the installation surface H is horizontal. In the present embodiment, an acceleration sensor 22a is used for detecting the installation angle of the projector 1. The acceleration sensor 22a is mounted inside the projector 1, and detects the acceleration acting in the leftward direction (toward the rear of the projector 1) on the dashed line shown in FIG. 3.

As shown in FIG. 3, in the case in which the projector 1 is installed tilted with the installation angle θ, the acceleration component on the dashed line is obtained as g·sin θ as shown in the drawing. The acceleration sensor 22a outputs the voltage corresponding to the acceleration component. Thus, the angle detection section 22 can detect the installation angle of the projector 1 based on the voltage value output from the acceleration sensor 22a. It should be noted that although it is assumed in the present embodiment that the acceleration sensor 22a is used, the acceleration sensor 22a is not a limitation, but any mechanism can be adopted providing it can detect the installation angle of the projector 1.

Going back to FIG. 1, the light source control section 23 controls supply and stop of the power to the light source 11 based on the instruction from the control section 20, thus switching the light source 11 between the lighting state and the extinction state.

The second time storing section 24 is formed of a nonvolatile memory device, and stores the setting value of the second time. Reading from and writing to the second time storing section 24 are performed by the control section 20.

The image signal input section 31 is provided with various image input terminals for connection with external image supply device (not shown) such as a personal computer or a video reproduction device via a cable, and the image signal is input from the image supply device. The image signal input section 31 converts the image signal thus input into image data with a format, which can be processed by the image processing section 32, and then outputs the image data to the image processing section 32.

Based on the instructions from the control section 20, the image processing section 32 executes various image quality control process such as an adjustment of brightness, contrast, sharpness, or color, or gamma correction on the image data input from the image signal input section 31. Further, the image processing section 32 performs the process of overlapping an on-screen display (OSD) image on the image data if necessary. The image processing section 32 outputs the image data, on which the adjustment and the process described above are executed, to the keystone distortion correction section 33.

In order for preventing the distortion (the keystone distortion) that the projection image is enlarged in the direction of the tilt when projecting the image in the condition in which the projector 1 is tilted with respect to the screen SC, the keystone correction section performs correction (the keystone distortion correction) of the image data thus input. Based on the information of the keystone distortion correction instruction input from the input operation section 21 and the information of the installation angle of the projector 1 detected by the angle detection section 22, the control section 20 provides the keystone distortion correction section 33 with an instruction of performing the keystone distortion correction, and the keystone distortion correction section 33 performs the keystone distortion correction.

The keystone distortion correction is for skipping the pixel values from the image data, thereby shrinking the projection image so that the more a part of the projection image is shrunk, the further the position of the part in the projection image proceeds along the direction of the tilt, and the keystone distortion correction section 33 outputs the image data thus corrected to the light valve drive section 14. It should be noted that in the case in which the keystone distortion correction is not performed, the image data output from the image processing section 32 is directly output to the light valve drive section 14. When the light valve drive section 14 drives the liquid crystal light valve 12 in accordance with the image data input, namely the pixel value of each of the pixels 12p, the image corresponding to the image data is projected on the screen SC.

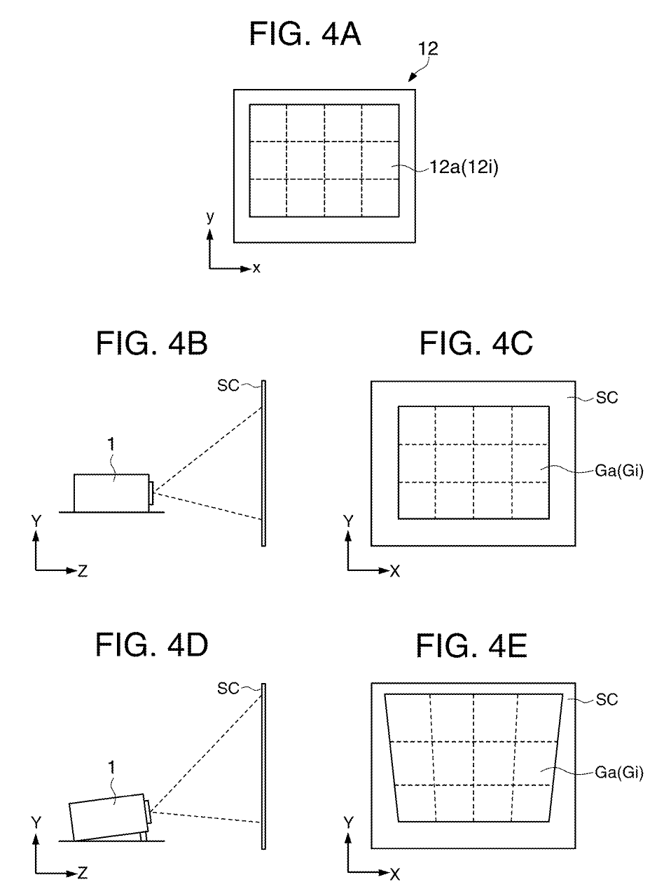

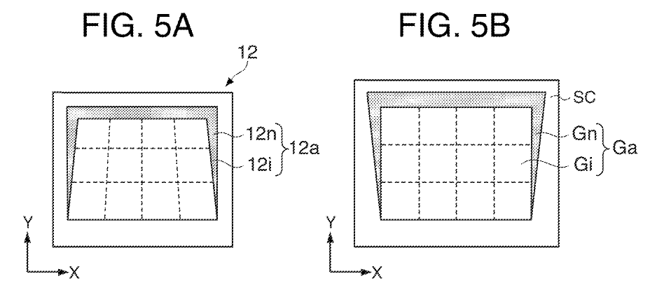

Then, the keystone distortion correction by the keystone distortion correction section 33 will be explained using FIGS. 4A through 4E, 5A, and 5B.

FIGS. 4A through 4E are explanatory diagrams for explaining the keystone distortion, and show the state in which no keystone distortion is executed on the image data. Here, FIG. 4A is a front view of the liquid crystal light valve viewed from the light entrance side, FIG. 4B is a side view showing how the projector performs projection horizontally, and FIG. 4C is a front view showing the projection image displayed on the screen in this case. Further, FIG. 4D is a side view showing how the projection is performed in the state in which the projector is tilted, and FIG. 4E is a front view showing the projection image displayed on the screen on that occasion.

It should be noted that in FIGS. 4A through 4E it is assumed that the lateral directions (the horizontally lateral directions) are denoted as ±x directions, and the upper and lower directions (the vertically upper and lower directions) are denoted as ±y directions when facing the liquid crystal light valve 12, and that the lateral directions (the horizontally lateral directions) are denoted as ±X directions, and the upper and lower directions (the vertically upper and lower directions) are denoted as ±Y directions when facing the screen SC. Here, the X directions and the Y directions of the screen SC correspond respectively to the x directions and the y directions of the liquid crystal light valve 12, and for example, the light transmitted through the pixel located in the upper right (+x, +y side) of the pixel area 12a is projected on the upper right (+X, +Y side) of the screen SC.

Further, in FIGS. 4A through 4E, 5A, and 5B, the lattice-like pattern shown in the pixel area 12a or the projection image Ga is formed of lines supplementarily added thereto in order for showing the correspondence between the image formed in the pixel area 12a and the projection image Ga projected on the screen SC, but does not mean that such a pattern is actually displayed.

As shown in FIG. 4A, in the case in which no keystone distortion correction is performed, the liquid crystal light valve 12 forms the image (an input image Gi), which is based on the image data input from the keystone distortion correction section 33, in the entire pixel area 12a. In other words, in this case, the area (an image forming area 12i) for forming the input image Gi is identical to the image area 12a. Here, as shown in FIGS. 4B and 4C, in the case in which the projector 1 is installed horizontally, and performs the projection without the tilt with respect to the screen SC, the projection image Ga (the input image Gi) displayed on the screen SC becomes to have a rectangular shape identical to that of the pixel area 12a.

On the other hand, as shown in FIGS. 4D and 4E, in the case in which the projector 1 is installed with a tilt with respect to the screen SC, and the projection toward the upper side (+Y direction) is performed, the projection image Ga displayed on the screen SC is enlarged so that the further the position of the part of the projection image Ga moves in the direction (+Y direction) of the tilt, the more the part of the projection image Ga is enlarged in the ±X directions and +Y direction, and is thus distorted. In the present embodiment, the keystone distortion correction performed in the case in which the oblique projection with the tilt in the +Y direction (the vertical direction) is performed will be described.

FIGS. 5A and 5B are explanatory diagrams for explaining the keystone distortion correction, wherein FIG. 5A is a front view of the liquid crystal light valve 12 viewed from the light entrance surface side, and FIG. 5B is a front view showing the projection image displayed on the screen SC when performing the oblique projection.

The keystone distortion correction section 33 performs the skipping of the pixel values from the image data input from the image processing section 32, thereby executing the correction in which the further the position of the part of the projection image Ga moves in the direction (+Y direction) of the tilt, the more the part of the projection image Ga is shrunk compared to the case in which the correction is not executed. Specifically, as shown in FIGS. 5A and 5B, the keystone distortion correction section 33 sets the image forming area 12i having a trapezoidal shape oriented oppositely to the projection image Ga, namely the shape having the lateral dimension tapering along the direction (+y direction) of the tilt, in the pixel area 12a of the liquid crystal light valve 12. Further, the higher degree of enlargement due to the tilted projection is set at a position, the more pixels the keystone distortion correction section 33 skips at the position, thereby forming the input image Gi in the image forming area 12i.

Further, the keystone distortion correction section 33 corrects the image data so that the light transmission of each of the pixels 12a included in an area 12n surrounding the image forming area 12i becomes the minimum. As a result, since the deformation of the input image Gi due to the oblique projection can be corrected, and at the same time, the light is hardly applied to the area Gn in the projection image Ga, corresponding to the area 12n, the input image Gi is displayed on the screen SC with the normal shape (the rectangular shape) as shown in FIG. 5B. It should be noted that in order for making up for the lack in the grayscale information due to the skipping of the pixel values, it is desirable to correct the pixel values of the pixels adjacent to the pixels which are an object of the skipping in accordance with the pixel values to be skipped.

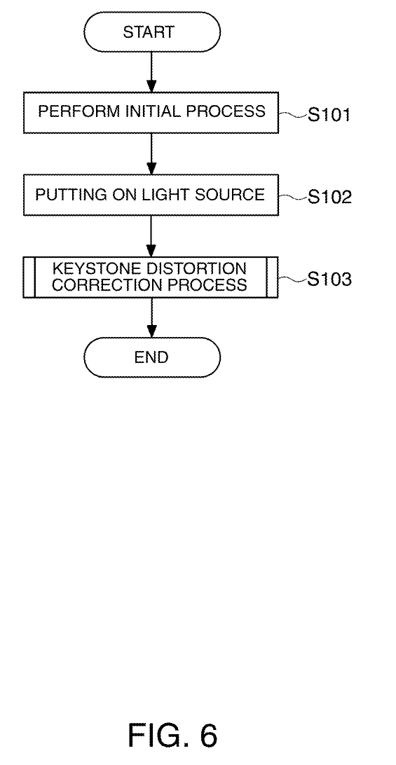

The operation performed when the projector 1 is powered on will hereinafter be explained. FIG. 6 is a flowchart of a process executed when the projector 1 is powered on.

When the power key provided to the input operation section 21 is held down, and thus a signal corresponding to the power-on of the projector 1 is input, the control section 20 performs an initial process (step S101). In the present embodiment, initialization of the CPU and initialization of the memory such as the RAM are performed in the initial process. Further, initialization of the software and the hardware is also performed besides the above. Subsequently, the control section 20 issues an instruction to the light source control section 23 to light the light source 11 (step S102).

Then, the control section 20 performs (step S103) the keystone distortion correction process (a subroutine). Subsequently, the process upon powering on the projector 1 is terminated.

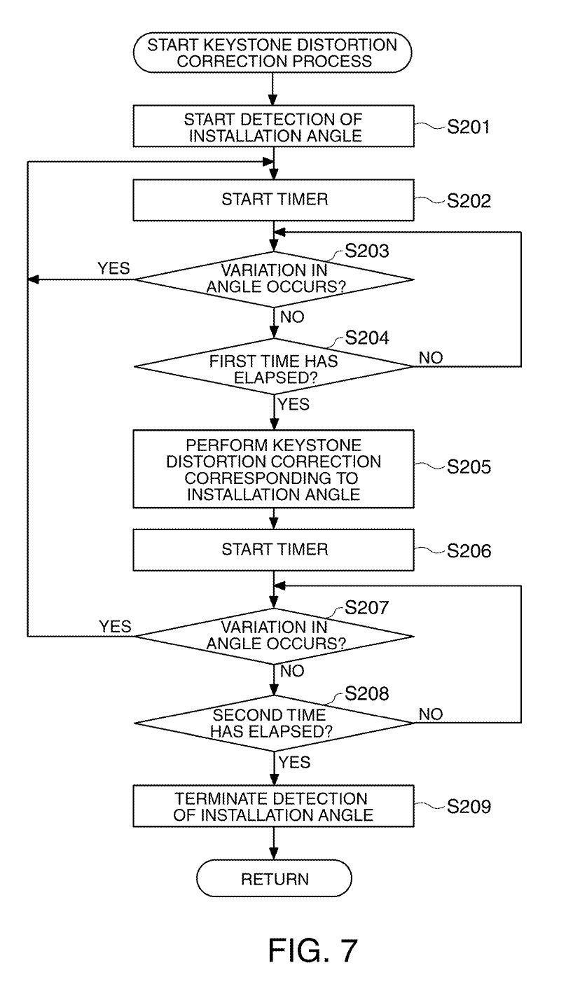

Then, the keystone distortion correction process (the subroutine) of the projector 1, namely the process of performing the keystone distortion correction in accordance with the installation angle, will be explained. FIG. 7 is a flowchart of the keystone distortion correction process of the projector 1.

The control section 20 issues an instruction to the angle detection section 22 to start the detection of the installation angle of the projector 1 (step S201). Subsequently, the control section 20 starts the timer 20a in order for measuring the first time (step S202). Then, the angle detection section 22 detects the installation angle, and informs the control section 20 of the result, and then the control section 20 determines whether or not a variation in the angle occurs in the installation angle thus informed (step S203). In other words, the control section 20 determines whether or not the projector 1 is fluctuating. The angle detection section 22 at this moment corresponds to a fluctuation detection section. Here, in the present embodiment, whether or not the variation in the angle occurs is determined based on whether or not the variation in the angle falls within the range with the difference smaller than three degrees from the installation angle detected in the previous detection. It should be noted that the angle with which it is determined that the variation in the angle occurs is not limited to three degrees.

If there is the variation in the angle (YES in the step S203), the process returns to the step S202. If there is no variation in the angle (NO in the step S203), the control section 20 refers to the timer 20a to determine whether or not the first time has elapsed (step S204). In the present embodiment, the first time is assumed to be three seconds. If the first time has not yet elapsed (NO in the step S204), the process returns to the step S203.

When the first time has elapsed (YES in the step S204), the control section 20 determines that the settled state of the fluctuation has been reached, and instructs the keystone distortion correction section 33 about the execution of the keystone distortion correction corresponding to the installation angle at that moment to, and then the keystone distortion correction section 33 performs keystone distortion correction (step S205). The control section 20 and the keystone distortion correction section 33 at this moment correspond to a distortion correction section.

Subsequently, the control section 20 starts the timer 20a in order for measuring the second time (step S206). Then, the angle detection section 22 detects the installation angle, and inform the control section 20 of the result, and then the control section 20 determines whether or not a variation in the angle occurs in the installation angle thus informed (step S207). In other words, the control section 20 determines whether or not the projector 1 is fluctuating.

If there is the variation in the angle (YES in the step S207), the process returns to the step S202. If there is no variation in the angle (NO in the step S207), the control section 20 refers to the timer 20a to determine whether or not the second time stored in the second time storing section 24 has elapsed (step S208). In the present embodiment, the second time is assumed to be thirty seconds. If the second time has not yet elapsed (NO in the step S208), the process returns to the step S207.

When the second time has elapsed (YES in the step S208), the control section 20 determines that the fluctuation settled state is maintained, and issues an instruction to the angle detection section 22 to terminate the detection of the installation angle of the projector 1 (step S209). Then, the keystone distortion correction process is terminated (return from the subroutine).

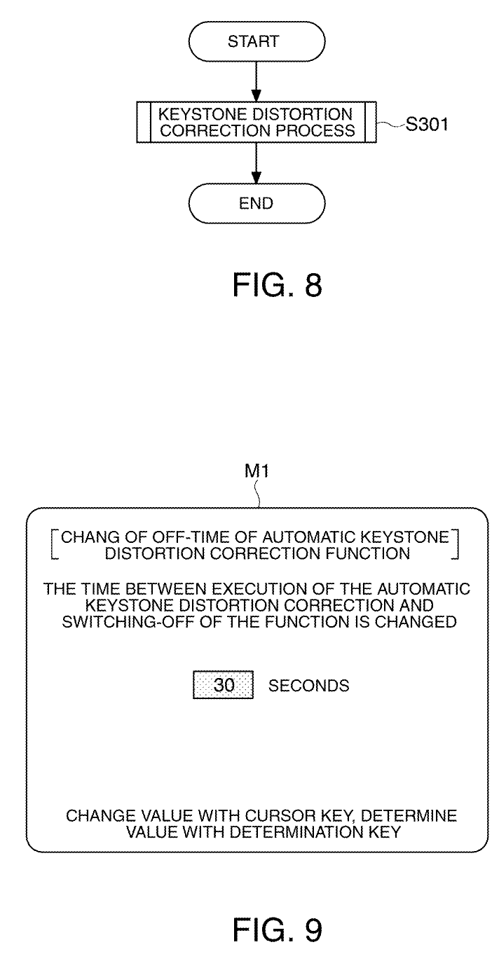

Further, in the projector 1 of the present embodiment, the keystone distortion correction process can be executed in response to holding down of the keystone distortion correction key provided to the input operation section 21. Then, the operation performed when the keystone distortion correction key of the projector 1 is held down during the image projection will be explained. FIG. 8 is a flowchart of the process executed when a keystone distortion correction key of the projector 1 is held down.

When the keystone distortion correction key provided to the input operation section 21 is held down, the control section 20 executes (step S301) the keystone distortion correction process (the subroutine). Then, the process executed when the keystone distortion correction key is held down is terminated. The operation of holding down the keystone distortion correction key at this moment corresponds to a predetermined input operation.

As described above, the projector 1 performs the keystone distortion correction process corresponding to the installation angle when the projector 1 is powered on, and when the keystone distortion correction key is held down. In the keystone distortion correction process, the detection of the installation angle is terminated when the second time (30 seconds) has elapsed from the completion of the keystone distortion correction. If the variation in the angle occurs in the projector 1 before the second time elapses, the projector 1 performs the keystone distortion correction again. In the present embodiment, it is arranged that the second time can be changed.

A method of changing the second time will hereinafter be explained. It is assumed that an item of “changing the second time” is provided to the setting menu implemented as the software in the projector 1, and the second time can be changed by the user operating the menu key, the cursor key, the determination key, and so on provided to the input operation section 21.

FIG. 9 is a diagram of a menu screen for changing the second time. Here, the “second time” is described as the “off-time of automatic keystone distortion correction function.” As shown in FIG. 9, the second time which can be changed, and a message are displayed on the second time changing screen Ml. The message that “the time between execution of the automatic keystone distortion correction and switching-off of the function is changed” is displayed. Further, as the second time which can be changed, the value of “30 seconds” is displayed. Here, the “30 seconds” is a default value. The user operates the cursor key and the determination key provided to the input operation section 21, thereby changing the second time to be the value representing the desired time. When the user changes the second time, the control section 20 stores the time thus changed in the second time storing section 24. The control section 20 and the second time storing section 24 correspond to a time changing section.

According to the embodiment described above, the following advantages can be obtained.

1. The projector 1 executes the keystone distortion correction process when powering-on the projector 1. Thus, even the user who is not familiar with the operation of the projector 1 can easily obtain the projection image, on which the keystone distortion correction is executed, simply by installing the projector 1 and powering on the projector 1.

2. The projector 1 executes the keystone distortion correction process when holding down the keystone distortion correction key. Thus, it is possible for the user to make the projector 1 execute the keystone distortion correction process at desired timing, thereby obtaining the projection image on which the keystone distortion correction is executed even after the keystone distortion correction process has been executed upon powering on the projector 1.

3. The projector 1 starts the detection of the variation in the angle (state of fluctuation) when the execution of the keystone distortion correction process is instructed. Subsequently, when the first time has elapsed while keeping the state (the fluctuation settled state) without the variation in the angle, the projector 1 performs the keystone distortion correction in accordance with the installation angle. In other words, the projector 1 executes the automatic keystone distortion correction function. Thus, it becomes possible to prevent the keystone distortion correction from being executed due to the fluctuation while the user is executing the installation or the angle adjustment of the projector 1. In other words, the flicker in the projection image caused by performing the keystone distortion correction can be reduced.

Further, the projector 1 terminates the detection of the installation angle when the second time has elapsed while keeping the state without the variation in the angle after the completion of the keystone distortion correction. Thus, since the keystone distortion correction is never executed after the termination of the detection of the installation angle even if the user erroneously fluctuates the projector, the flicker in the projection image due to the keystone distortion correction can be prevented.

As described above, the projector 1 can reduce the flicker in the projection image due to the automatic keystone distortion correction function.

4. The projector 1 terminates the detection of the installation angle when the second time has elapsed while keeping the state without the variation in the angle from the completion of the keystone distortion correction. Thus, since it becomes possible to stop the power supply to the angle detection section 22 (i.e., the acceleration sensor 22a), the power consumption can be reduced.

5. The projector 1 detects the fluctuation of the projector 1 using the angle detection section 22. Thus, since the circuit configuration as the fluctuation detection section becomes unnecessary, the circuit configuration of the projector 1 can be simplified.

6. In the projector 1, the user can change the second time stored in the second time storing section 24 using the setting menu. In other words, the second time from the completion of the keystone distortion correction to the termination of the detection of the installation angle can be changed. Thus, the second time can be changed in accordance with the intention of the user. For example, in the case in which it is intended to quickly prevent the flicker in the image caused by erroneously fluctuating the projector, or the case in which it is intended to reduce the power consumption, it is desirable to set the second time to be rather short. Further, in the case in which the user prefers to take his or her time to perform the installation of the projector and the angle adjustment thereof, it is desirable to set the second time to be rather long.

It should be noted that the embodiments describe above are not limitations, but it is possible to put the embodiments into practice by adding various modifications or improvements. Some modified examples will be described below.

### Modified Example 1

Although in the embodiment described above, it assumed that the keystone distortion correction process is executed when the keystone distortion correction key provided to the input operation section 21 is held down, it is also possible to provide the item of “execution of the automatic keystone distortion correction” to the setting menu installed in the projector 1 as the software, and to execute the keystone distortion correction process by the user operating the menu key, the cursor key, the determination key, and so on provided to the input operation section 21.

### Modified Example 2

Although in the embodiment described above, it is assumed that the keystone distortion correction process is executed when the keystone distortion correction key provided to the input operation section 21 is held down, it is also possible to provide an angle adjustment mechanism (not shown) capable of adjusting the installation angle of the projector 1, and to execute the keystone distortion correction process when operating the angle adjustment mechanism. According to the configuration described above, since the keystone distortion correction process can be executed when the user performs the operation of varying the installation angle of the projector 1, the convenience thereof can be enhanced.

### Modified Example 3

Although in the embodiment described above, it is assumed that the fluctuation detection section is formed of the angle detection section 22, and the acceleration sensor 22a provided to the angle detection section 22 detects the variation in the installation angle, it is also possible to provide the fluctuation detection section (not shown) in addition to the angle detection section 22 to detect the variation in the angle. The fluctuation detection section can include, for example, an acceleration sensor to detect the fluctuation of the projector 1.

### Modified Example 4

Although in the embodiment described above, it is assumed that the keystone distortion correction is executed in the condition in which the projector 1 is installed so as to be tilted in the vertical direction (+Y direction), it is also possible to assume that the keystone distortion correction is executed in the condition of tilting the projector 1 in other directions (−Y direction, ±X directions (the horizontal directions)). In the case in which the projector 1 is tilted in the −Y direction, the keystone distortion correction can be executed by detecting the installation angle using the acceleration sensor 22a similarly to the embodiment described above. Further, in the case in which the projector 1 is tilted in the ±X directions (the horizontal directions), the adjustment of the zoom condition and the correction of the keystone distortion so that the projection image does not run off the surface of the screen SC by performing the “zoom adjusting keystone correction process” disclosed in JP-2006-5534, for example.

### Modified Example 5

Although in the embodiment described above the first time is assumed to be 3 seconds, the first time is not limited to 3 seconds. Further, it is also possible to arrange that the first time can be set by the user. For example, it is assumed that an item of “setting the first time” is provided to the setting menu implemented as the software in the projector 1, and the first time can be changed and set by the user operating the menu key, the cursor key, the determination key, and so on provided to the input operation section 21. According to the configuration described above, it becomes possible for the user to arbitrarily set the first time from when the variation in the angle is settled to when the keystone distortion correction is executed.

### Modified Example 6

Although in the embodiments described above the transmissive liquid crystal light valve 12 is used as the light modulation device, it is also possible to use a reflective light modulation device such as a reflective liquid crystal light valve. Further, a micromirror array device for modulating the light emitted from the light source by controlling the emission direction of the incident light of every micromirror as a pixel can also be used.

What is claimed is:

1. A projector adapted to perform a keystone distortion correction for correcting keystone distortion of an image projected on a projection surface, the projector comprising:
a fluctuation detection section adapted to start detection of fluctuation state of the projector in response to a predetermined instruction signal;
an angle detection section adapted to detect an installation angle of the projector;
a distortion correction section adapted to perform the keystone distortion correction, in response to detection of a fluctuation settled state by the fluctuation detection section, in accordance with the installation angle detected by the angle detection section; and
a control section adapted to terminate the detection of the fluctuation state by the fluctuation detection section in response to elapse of second time while keeping the fluctuation settled state from completion of the keystone distortion correction by the distortion correction section.

2. The projector according to claim 1, wherein
the distortion correction section performs the keystone distortion correction in response to elapse of first time while keeping the fluctuation settled state from detection of the fluctuation settled state by the fluctuation detection section.

3. The projector according to claim 1, wherein
the fluctuation detection section is formed with the angle detection section, and adopts a variation state of the installation angle detected by the angle detection section as the fluctuation state of the projector.

4. The projector according to claim 1, further comprising:
a time changing section capable of changing the second time.

5. The projector according to claim 1, wherein
the predetermined instruction signal is a signal corresponding to powering on of the projector.

6. The projector according to claim 1, further comprising:
an input operation section adapted to receive an input operation,
wherein the predetermined instruction signal is a signal corresponding to a predetermined input operation to the input operation section.

7. A method of controlling a projector adapted to perform a keystone distortion correction for correcting keystone distortion of an image projected on a projection surface, the method comprising the steps of:
(a) starting detection of fluctuation state of the projector in response to a predetermined instruction signal;
(b) detecting an installation angle of the projector;
(c) performing the keystone distortion correction, in response to detection of the fluctuation settled state in step (a), in accordance with the installation angle detected in step (b); and
(d) terminating the detection of the fluctuation state in step (a) in response to elapse of second time while keeping the fluctuation settled state from completion of the keystone distortion correction in step (c).
